(19) United States
(12) Patent Application Publication
(10) Pub. No.: US 2025/0282987 A1
(43) Pub. Date: Sep. 11, 2025

(54) INCORPORATING IMIDAZOLE-BASED NANOMATERIAL INTO DRILLING FLUIDS FOR EFFECTIVE HYDROGEN SULFIDE SCAVENGING DURING DRILLING OPERATIONS

(71) Applicant: KING FAHD UNIVERSITY OF PETROLEUM AND MINERALS, Dhahran (SA)

(72) Inventors: Sagheer A. ONAIZI, Dhahran (SA); Mustapha IDDRISU, Dhahran (SA)

(73) Assignee: KING FAHD UNIVERSITY OF PETROLEUM AND MINERALS, Dhahran (SA)

(21) Appl. No.: 18/599,461

(22) Filed: Mar. 8, 2024

(51) Int. Cl. C09K 8/08

(52) U.S. Cl. CPC C09K 8/08; C09K 2208/10; C09K 2208/20

(57) ABSTRACT

A method of removing hydrogen sulfide from a subterranean geological formation includes mixing a cobalt-imidazolate ZIF-67 material in an amount of 0.5 to 2.5 weight percentage (wt. %) with an aqueous fluid to form a drilling fluid suspension with a pH of 10 or more. The method further includes injecting the drilling fluid suspension in the subterranean geological formation including one or more hydrocarbons and circulating the drilling fluid suspension in the subterranean geological formation and forming a water-based mud. The method further includes scavenging hydrogen sulfide from the subterranean geological formation, where the hydrogen sulfide reacts with the cobalt-imidazolate ZIF-67 material during scavenging.

### STATEMENT REGARDING PRIOR DISCLOSURE BY THE INVENTORS

Aspects of the present disclosure are described in Onaizi, S. A. and Iddrisu, M., “H₂S scavenging performance and rheological properties of water-based drilling fluids comprising ZIF-67” published in Issue 228, Geoenergy Science and Engineering, which is incorporated herein by reference in its entirety.

### STATEMENT OF ACKNOWLEDGEMENT

Support provided by the Deanship of Research Oversight and Coordination (DROC), King Fahd University of Petroleum and Minerals, Saudi Arabia through project number DF191027 is gratefully acknowledged.

### BACKGROUND

### Technical Field

The present disclosure is directed to a method of hydrogen sulfide scavenging, and more particularly, directed to a method removing hydrogen sulfide (H₂S) from a subterranean geological formation.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present invention.

Presently, fossil fuel demand is at a peak, and to produce more crude oil from fossil fuels, drilling operations are required to extract the said fossil fuels. Drilling in an oil field includes a plurality of components; one such component is drilling fluid. Drilling fluids are multi-component systems that contain many additives carefully formulated to perform specific functions during drilling operations. Some of these functions include providing hydrostatic control, maintaining wellbore stability, minimizing the corrosion of handling equipment, controlling formation pressure, cooling and lubricating the drilling bit, suspending and circulating the drilling cuttings, sealing the permeable well formations, and minimizing formation damage [Jinasena, A. and Sharma, R., Estimation of mud losses during the removal of drill cuttings in oil drilling, SPE J., 2020, 25 (05): 2162-2177]. The choice and quantity of additives that make up drilling fluids contribute to attaining optimal rheological properties, fluid loss prevention, corrosion inhibition, and mitigation of sour gas exposure. Three main types of drilling fluids are currently used: water-based, oil-based, and synthetic-based mud. Water-based muds are generally preferred because they are relatively cheap, environmentally friendly, and less toxic. Even though oil-based and synthetic-based muds might offer better drilling performance, they are more expensive, difficult to handle, and environmentally unsafe due to the toxicity of the mineral oils and synthetic solvents used in their formulation [Katende, A., Boyou, N. v., Ismail, I., Chung, D. Z., Sagala, F., Hussein, N., Ismail, M. S., 2019. Improving the performance of oil based mud and water based mud in a high temperature hole using nano silica nanoparticles].

In drilling subsurface formations, sulfhydryl compounds, such as mercaptans, thiols, dithiol acids, and the like, may cause operational issues. Among the sulfhydryl compounds, hydrogen sulfide (H₂S) is one of the most encountered. H₂S exists naturally in oil and gas reservoirs due to the biological decomposition of sulfate-containing organic matter or minerals by the sulfate-reducing bacteria (SRB) under anaerobic conditions and by the thermochemical reduction (TCR) of reservoir biomass or other sulfhydryl compounds catalyzed by the presence of anhydrites [Dembicki Jr., H., Interpreting crude oil and natural gas data. In: Practical Petroleum Geochemistry for Exploration and Production, Elsevier, 2017, 135-188]. In addition to drilling operations, technologies employed for enhancing oil and gas production and recovery, such as water flooding of low permeable reservoirs, also account for generating H₂S. In such instances, SRB or other microbes from the surface penetrate, breed, and colonize the reservoir and subsequently induce the reduction of sulfate (SO₄²⁻) containing minerals and biomass, thereby increasing H₂S content. H₂S is a colorless, flammable, and highly toxic gas with a distinct odor of rotten egg, only detectable at low concentrations of 0.01 parts per million (ppm) to 1.5 ppm. The exposure to H₂S poses health and operational risks to drilling personnel, the equipment, and the rheology of drilling fluids. According to the Occupational Safety and Health Administration (OSHA) and the U.S. National Institute for Occupational Safety and Health (NIOSH), the maximum recommended or permissible H₂S exposure limits within a 10-minute period are 50 ppm and 10 ppm, respectively. Prolonged exposure, even at low H₂S concentrations (<50 ppm), may cause adverse health effects, such as respiratory disturbances, loss of consciousness, and eventually death. The exposure of metallic structures to H₂S induces pitting corrosion due to the formation of ferrous sulfide scale and free hydrogen ions. The free hydrogen ions penetrate metallic structures, causing hydrogen embrittlement, which may lead to further equipment failures [Orlikowski, J., Jazdzewska, A., Uygur, I., Gospos, R., Olczak, T., Darowicki, K., Effect of wet hydrogen sulfide on carbon steels degradation in refinery based on case study, Arabian J. Sci. Eng., 2022]. Further, the presence of H₂S in drilling environments negatively affects the rheology of the utilized mud. The exposure of drilling mud to H₂S may lead to a decrease in mud viscosity, reduction of gel strength, and compromise wellbore stability. Furthermore, H₂S is both toxic and explosive, so protective measures must be taken to prevent its build-up [Onaizi, S. A., Gawish, M. A., Murtaza, M., Gomaa, I., Tariq, Z., Mahmoud, M., H₂S scavenging capacity and rheological properties of water-based drilling muds, ACS Omega, 2020, 5, 30729-30739]. Such H₂S build-up may result in serious health, safety, and economic penalties, requiring the proper mitigation of this life-threatening gas during drilling operations.

Several classes of materials have been studied and incorporated into drilling fluid formulations for H₂S scavenging. These classes of material generally remove H₂S through chemical reactions or physical adsorptive mechanisms that capture H₂S from sour streams, eliminating the health and operational risks from exposure to this lethal gas. Materials such as transition metals, oxidizing agents, amines, aldehydes, and triazine have been widely studied [Murtaza, M., Alarifi, S. A., Abozuhairah, A., Mahmoud, M., Onaizi, S. A., Al-Ajmi, M., Optimum selection of H₂S scavenger in light-weight and heavy-weight water-based drilling fluids, ACS Omega, 2021, 6, 24919-24930]. These scavengers are available either in solid or liquid form. One of the technical requirements is that incorporating an H₂S scavenger into a drilling fluid should not adversely affect its rheological properties.

Recently, metal organic frameworks (MOFs) have been prioritized for several applications in fields such as gas purification, separation processes, catalysis, chemical sensing, proton conduction, and drug delivery. The interest in utilizing MOFs in these applications is fueled by the properties these MOFs possess, such as large surface area, tune-able pore size, surface functionalities, and good thermal stability [Furukawa, H., Cordova, K. E., O'Keeffe, M., Yaghi, O. M., The chemistry and applications of metal-organic frameworks, Science, 2013, 1979, 341]. MOFs are inorganic-organic hybrids with extremely high porosity and crystallinity. MOFs are made up of networks of metal-ion anodes connected to polydentate organic ligands through coordinate bonds. Although some MOFs have demonstrated good performance towards the sorption of polar and non-polar gases under dry conditions, the structures of most MOFs tend to collapse in aqueous media due to the weakening of their metal-organic ligand coordinate bonds. This water instability limits the applications of MOFs in operations where aqueous media, such as drilling operations, are encountered.

Recently, a new class of MOFs, namely, zeolitic imidazolate frameworks (ZIFs), has emerged as more water-stable materials with usually better textural properties, tunability, and thermal/chemical stability. These ZIFs are composed of Co²⁺/Zn²⁺ and an imidazole ligand. The ZIFs show a similar morphology as conventional zeolites. ZIF-67 possesses exceptional water stability, abundant uncoordinated open metal sites, ease of fabrication in aqueous media, high yield, and potential for utilization in water phase applications [Duan, C., Yu, Y., Hu, H., Recent progress on synthesis of ZIF-67-based materials and their application to heterogeneous catalysis, Green Energy & Environment, 2022, 7, 3-15]. A plurality of MOFs- and ZIFs-based drilling solutions have been developed; however, there is still need for a sustainable and economically viable solution for H₂S removal from subterranean geological formations.

Accordingly, an object of the present disclosure is to develop a method of removing hydrogen sulfide (H₂S) from subterranean geological formations that may circumvent the drawbacks of traditional methods.

### SUMMARY

In an exemplary embodiment, a method of removing hydrogen sulfide from a subterranean geological formation is described. The method includes mixing a cobalt-imidazolate ZIF-67 material with an aqueous fluid to form a drilling fluid suspension. The drilling fluid suspension has a pH of 10 or more and the cobalt-imidazolate ZIF-67 material is present in the drilling fluid suspension in an amount of 0.5 to 2.5 weight percentage (wt. %) based on the total weight of the drilling fluid suspension. Further, the method includes injecting the drilling fluid suspension in the subterranean geological formation including one or more hydrocarbons, and further circulating the drilling fluid suspension in the subterranean geological formation and forming a water-based mud. The method further includes scavenging hydrogen sulfide from the subterranean geological formation, where the hydrogen sulfide reacts with the cobalt-imidazolate ZIF-67 material during the scavenging.

In some embodiments, the cobalt-imidazolate ZIF-67 material has a Brunauer-Emmett-Teller (BET) surface area of 1000 to 1300 meters square per gram (m²/g).

In some embodiments, the cobalt-imidazolate ZIF-67 material has an average pore size of 1 to 3 nanometers (nm).

In some embodiments, the cobalt-imidazolate ZIF-67 material has a specific pore volume of 0.4 to 0.6 cubic centimeters per gram (cm³/g).

In some embodiments, the cobalt-imidazolate ZIF-67 material has an average particle size of 10 to 30 nm.

In some embodiments, the aqueous fluid includes at least water, a bentonite, an XC-polymer, a starch, a hydroxide, and a carbonate compound.

In some embodiments, a breakthrough time for the hydrogen sulfide in the presence of the drilling fluid suspension is 20 to 30 times greater compared to a breakthrough time for the hydrogen sulfide in the presence of the drilling fluid suspension without the cobalt-imidazolate ZIF-67 material.

In some embodiments, a saturation time for the hydrogen sulfide in the presence of the drilling fluid suspension is 2 to 6 times greater compared to a saturation time for the hydrogen sulfide in the presence of the drilling fluid suspension without the cobalt-imidazolate ZIF-67 material.

In some embodiments, a breakthrough capacity for the hydrogen sulfide in the presence of the drilling fluid suspension is 20 to 30 times greater compared to a breakthrough capacity for the hydrogen sulfide in the presence of the drilling fluid suspension without the cobalt-imidazolate ZIF-67 material.

In some embodiments, a saturation capacity for the hydrogen sulfide in the presence of the drilling fluid suspension is 4 to 8 times greater compared to a saturation capacity for the hydrogen sulfide in the presence of the drilling fluid suspension without the cobalt-imidazolate ZIF-67 material.

In some embodiments, a plastic viscosity of the drilling fluid suspension is 1.1 to 1.5 times greater compared to a plastic viscosity of the drilling fluid suspension without the cobalt-imidazolate ZIF-67 material.

In some embodiments, an apparent viscosity of the drilling fluid suspension is 1.1 to 1.6 times greater compared to an apparent viscosity of the drilling fluid suspension without the cobalt-imidazolate ZIF-67 material.

In some embodiments, the method includes scavenging hydrogen sulfide thereby converting hydrogen sulfide into a hydrosulfide.

In some embodiments, the hydrosulfide is bound to uncoordinated open metal cobalt(II) sites and basic nitrogen sites in the cobalt-imidazolate ZIF-67 material.

In some embodiments, the method includes scavenging hydrogen sulfide thereby converting hydrogen sulfide into elemental sulfur and an insoluble sulfide.

In some embodiments, a gel strength of the drilling fluid suspension at a time of 10 seconds is 2 to 5 times greater compared to a gel strength of the drilling fluid suspension without the cobalt-imidazolate ZIF-67 material at a time of 10 seconds.

In some embodiments, a gel strength of the drilling fluid suspension at a time of 10 minutes is 1.5 to 3.5 times greater compared to a gel strength of the drilling fluid suspension without the cobalt-imidazolate ZIF-67 material at a time of 10 minutes.

In some embodiments, the method further includes flowing hydrogen sulfide gas into the drilling fluid suspension.

In some embodiments, the hydrogen sulfide gas is seeded in methane at a concentration of 100 parts per million volume (ppmv).

In some embodiments, the method further includes flowing hydrogen sulfide gas at a rate of 50 to 150 milliliters per minute (mL/min).

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof may be readily obtained as the same becomes better understood by reference to the following detailed description when considered in connection with the accompanying drawings, wherein:

FIG. 1A is a flow chart of a method for removing hydrogen sulfide (H₂S) from a subterranean geological formation, according to certain embodiments;

FIG. 1B is a schematic illustration of an H₂S scavenging experimental setup, according to certain embodiments;

FIG. 2 depicts a Fourier-transform infrared (FTIR) spectrum of zeolitic imidazole framework-67 (ZIF-67) nanoparticles (NP), according to certain embodiments;

FIG. 3 depicts X-ray diffraction (XRD) patterns of the ZIF-67 NPs, according to certain embodiments;

FIG. 4 depicts nitrogen (N₂) adsorption/desorption isotherms on/from the ZIF-67 NPs, according to certain embodiments;

FIG. 5 depicts thermal stability of the ZIF-67 NPs measured using thermogravimetric analysis (TGA) under N₂ gas environment, according to certain embodiments;

FIG. 6 depicts H₂S scavenging breakthrough curve using a base-containing water-based drilling fluid and a ZIF-67-containing water-based drilling fluid, according to certain embodiments;

FIG. 7 is a schematic illustration of the structural information of the ZIF-67 NPs and a mechanism of H₂S scavenging on the ZIF-67 NPs, according to certain embodiments;

FIG. 8 depicts influence of the ZIF-67 NPs on the viscosity of the formulated water-based mud (WBM), according to certain embodiments;

FIG. 9 depicts the influence of the ZIF-67 NPs on yield point and carrying capacity of the WBM, according to certain embodiments;

FIG. 10 depicts the influence of the ZIF-67 NPs on the 10 second (s) and 10 minutes (min) gel strength of the WBM, according to certain embodiments;

FIG. 11 depicts American Petroleum Institute (API) fluid loss of base mud and 1 weight percentage (wt. %) ZIF-67 mud formulations, according to certain embodiments;

FIG. 12A is an image of a filter cake obtained from the API filter press after 30 minutes without the ZIF-67 NPs, according to certain embodiments;

FIG. 12B is an image of a filter cake obtained from the API filter press after 30 minutes with 1.0 wt. % ZIF-67 NPs, according to certain embodiments;

FIG. 13 depicts shear stress-shear rate curves of the base mud and the ZIF-67 WBM formulations, according to certain embodiments;

FIG. 14A depicts rheological modelling of the base mud, according to certain embodiments;

FIG. 14B depicts rheological modelling of the ZIF-67 NPs containing mud at 0.05 wt. % concentration, according to certain embodiments;

FIG. 14C depicts rheological modelling of the ZIF-67 NPs containing mud at 0.25 wt. % concentration, according to certain embodiments;

FIG. 14D depicts rheological modelling of the ZIF-67 NPs containing mud at 0.50 wt. % concentration, according to certain embodiments;

FIG. 14E depicts rheological modelling of the ZIF-67 NPs containing mud at 0.75 wt. % concentration, according to certain embodiments; and

FIG. 14F depicts rheological modelling of the ZIF-67 NPs containing mud at 1.0 wt. % concentration, according to certain embodiments.

### DETAILED DESCRIPTION

In the following description, it is understood that other embodiments may be utilized, and structural and operational changes may be made without departure from the scope of the present embodiments disclosed herein.

References will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the words “a” and “an” and the like carry the meaning of “one or more.” Within the description of this disclosure, where a numerical limit or range is stated, the endpoints are included unless stated otherwise. Also, all values and subranges within a numerical limit or range are specifically included as if explicitly written out.

As used herein, the term “zeolitic material” or “zeolitic framework” refers to a material having the crystalline structure or three-dimensional framework of, but not necessarily the elemental composition of, a zeolite. Zeolites are porous silicate or aluminosilicate minerals that occur in nature. Elementary building units of zeolites are SiO₄ (and, if appropriate, AlO₄) tetrahedra. Adjacent tetrahedra are linked at their corners via a common oxygen atom, which results in an inorganic macromolecule with a three-dimensional framework (frequently referred to as the zeolite framework). The three-dimensional framework of a zeolite also includes channels, channel intersections, and/or cages having dimensions in the range of 0.1-10 nanometers (nm), preferably 0.2-5 nm, and more preferably 0.2-2 nm. Water molecules may be present inside these channels, channel intersections, and/or cages. Zeolites that are devoid of aluminum may be referred to as “all-silica zeolites” or “aluminum-free zeolites.” Some zeolites which are substantially free of, but not devoid of, aluminum is referred to as “high-silica zeolites”. Sometimes, the term “zeolite” is used to refer exclusively to aluminosilicate materials, excluding aluminum-free zeolites or all-silica zeolites.

In some embodiments, the zeolitic material has a three-dimensional framework that is at least one zeolite framework selected from the group consisting of a 4-membered ring zeolite framework, a 6-membered ring zeolite framework, a 10-membered ring zeolite framework, and a 12-membered ring zeolite framework. The zeolite may have a natrolite framework (e.g., gonnardite, natrolite, mesolite, paranatrolite, scolecite, and tetranatrolite), edingtonite framework (e.g., edingtonite and kalborsite), thomsonite framework, analcime framework (e.g., analcime, leucite, pollucite, and wairakite), phillipsite framework (e.g., harmotome), gismondine framework (e.g., amicite, gismondine, garronite, and gobbinsite), chabazite framework (e.g., chabazite-series, herschelite, willhendersonite, and SSZ-13), faujasite framework (e.g., faujasite-series, Linde type X, and Linde type Y), mordenite framework (e.g., maricopaite and mordenite), heulandite framework (e.g., clinoptilolite and heulandite-series), stilbite framework (e.g., barrerite, stellerite, and stilbite-series), brewsterite framework, cowlesite framework, and the like.

Aspects of the present disclosure are directed to a method for removing hydrogen sulfide (H₂S) from a subterranean geological formation using a zeolitic imidazolate framework-67 (ZIF-67) is described. The H₂S scavenging performance of ZIF-67 nanoparticles (NPs) and its effect on the rheological and fluid loss properties of water-based drilling mud is studied and the results indicate that the incorporation of the ZIF-67 NPs into the drilling fluids has been found to enhance the H₂S scavenging performance, improve the plastic viscosity (PV), apparent viscosity (AV), yield point (YP), carrying capacity, and gel strength (GS) of the base mud.

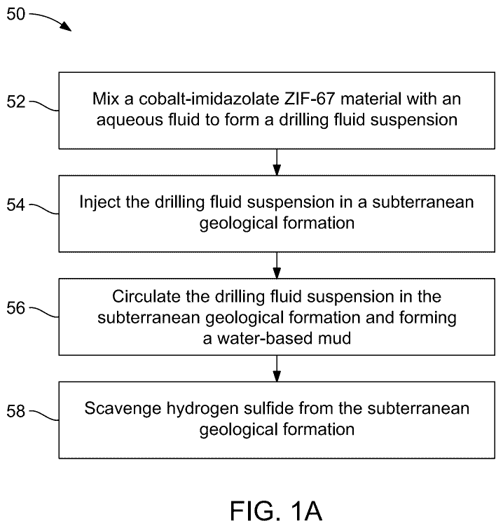

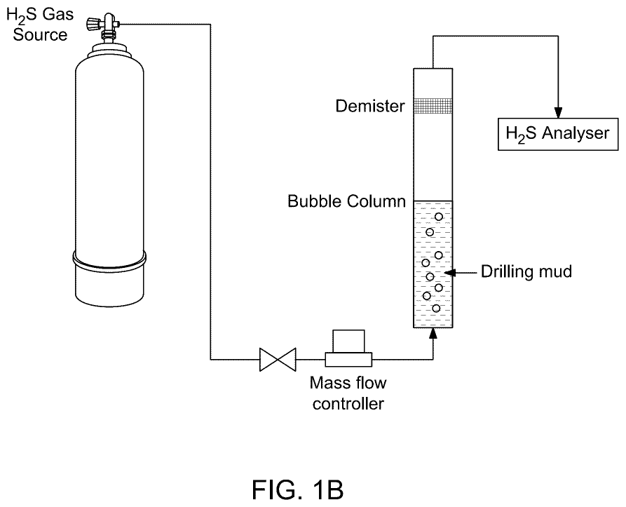

FIG. 1A illustrates a flow chart of a method 50 for removing hydrogen sulfide from a subterranean geological formation. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure. The subterranean geological formation may include, but is not limited to, a depleted oil reservoir, a depleted gas reservoir, a sour reservoir, a hydrocarbon hydrocarbon-bearing subterranean formation, a saline formation, an un-minable coal bed, and the like. In some embodiments, the method 50 may remove hydrogen sulfide from mixed production streams, water injection systems, produced water from an oil field, and the like.

At step 52, the method 50 includes mixing a cobalt-imidazolate ZIF-67 material with an aqueous fluid to form a drilling fluid suspension. In some embodiments, ZIF-67 material may be substituted by and/or used in combination with ZIF-1, ZIF-2, ZIF-3, ZIF-4, ZIF-5, ZIF-6, ZIF-7, ZIF-9, ZIF-10, ZIF-11, ZIF-12, ZIF-14, ZIF-20, ZIF-21, ZIF-22, ZIF-23, ZIF-25, ZIF-6, ZIF-61, ZIF-62, ZIF-63, ZIF-64, ZIF-65, ZIF-66, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-90, ZIF-91, ZIF-92, ZIF-93, ZIF-94, ZIF-96, ZIF-97, ZIF-100, ZIF-108, ZIF-303, ZIF-360, ZIF-365, ZIF-376, ZIF-386, ZIF-408, ZIF-410, ZIF-412, ZIF-413, ZIF-414, ZIF-486, ZIF-516, ZIF-586, ZIF-615, ZIF-725, the like, and a combination thereof.

The imidazolate forms the organic ligand in the cobalt-imidazolate ZIF-67 material. Imidazolate is the conjugate base of imidazole. Exemplary imidazole-based organic ligands include, but are not limited to, imidazole, 2-methylimidazole, 4-methylimidazole, 2-ethylimidazole, 2-isopropylimidazole, 4-tert-butyl-1H-imidazole, 2-ethyl-4-methylimidazole, 2-bromo-1H-imidazole, 4-bromo-1H-imidazole, 2-chloro-1H-imidazole, 2-iodoimidazole, 2-nitroimidazole, 4-nitroimidazole, (1H-imidazol-2-yl)methanol, 4-(hydroxymethyl)imidazole, 2-aminoimidazole, 4-(trifluoromethyl)-1H-imidazole, 4-cyanoimidazole, 3H-imidazole carboxylic acid, 4-imidazolecarboxylic acid, imidazole-2-carboxylic acid, 2-hydroxy-1H-imidazole-4-carboxylic acid, 4,5-imidazoledicarboxylic acid, 5-iodo-2-methyl-1H-imidazole, 2-methyl-4-nitroimidazole, 2-(aminomethyl)imidazole, 4,5-dicyanoimidazole, 4-imidazoleacetic acid, 4-methyl-5-imidazolemethanol, 1-(4-methyl-1H-imidazol-5-yl)methanamine, 4-imidazoleacrylic acid, 5-bromo-2-propyl-1H-imidazole, ethyl-(1H-imidazol-2-ylmethyl)-amine, 2-butyl-5-hydroxymethylimidazole, and the like.

The cobalt-imidazolate ZIF-67 material is present in the drilling fluid suspension in an amount of 0.5 to 2.5 weight percentage (wt. %), preferably 0.6 to 2.0 wt. %, more preferably 0.7 to 1.5 wt. %, and yet more preferably about 1 wt. %, based on the total weight of the drilling fluid suspension. In some embodiments, the cobalt-imidazolate ZIF-67 material has a Brunauer-Emmett-Teller surface area of 1000 to 1300 square meters per gram (m²/g), preferably 1100 to 1200 m²/g, more preferably 1150 to 1170 m²/g, and yet more preferably about 1158 m²/g. In some embodiments, the cobalt-imidazolate ZIF-67 material has an average pore size of 1 to 3 nm, preferably 1.5 to 2.5 nm, more preferably 1.6 to 1.8 nm, and yet more preferably about 1.71 nm. In some embodiments, the cobalt-imidazolate ZIF-67 material has a specific pore volume of 0.4 to 0.6 cubic centimeters per gram (cm³/g), preferably 0.45 to 0.55 cm³/g, more preferably 0.48 to 0.51 m²/g, and yet more preferably about 0.495 cm³/g. In some embodiments, the cobalt-imidazolate ZIF-67 material has an average particle size of 10 to 30 nm, preferably 15 to 25 nm, more preferably 18 to 22 nm, and yet more preferably about 20.7 nm.

In some embodiments, the cobalt-imidazolate ZIF-67 material may be a composite material with any other scavenger material, such as a metal-organic framework and the like, and/or a non-metal and/or metal support, including, but not limited to, graphene oxide, carbon nanotubes, activated carbon, layered double hydroxide, layer triple hydroxide, metal oxide, zeolites, the like, and a combination thereof.

In some embodiments, the cobalt-imidazolate ZIF-67 material may also include copper compounds, such as copper oxide, copper sulfate, copper molybdate, copper hydroxide, copper halide, copper carbonate, copper hydroxy carbonate, copper carboxylate, copper phosphate, copper hydrates and copper derivatives thereof, calcium salts, cobalt salts, nickel salts, lead salts, tin salts, zinc salts, iron salts, manganese salts, zinc oxide, iron oxides, manganese oxides, triazine, monoethanolamine, diethanolamine, caustic soda, the like, and combinations thereof.

In some embodiments, the aqueous fluid includes at least water, a bentonite, an XC-polymer, a starch, a hydroxide, and a carbonate compound. In some embodiments, the aqueous fluid may include brine/salt water. In some embodiments, the aqueous fluid may include hard water. In some embodiments, the aqueous fluid may include fresh water. In some embodiments, the brine/salt water, the hard water, and the fresh water may include salts of sodium, magnesium, calcium, potassium, ammonium, iron, and the like, and anions, such as chloride, bicarbonate, carbonate, sulfate, sulfite, phosphate, iodide, nitrate, acetate, citrate, fluoride, nitrite, and the like. In some embodiments, the water may be tap water, distilled water, deionized water, double distilled water, water purified by reverse osmosis, and the like.

The bentonite may refer to potassium bentonite, sodium bentonite, calcium bentonite, aluminum bentonite, and combinations thereof, depending on the relative amounts of potassium, sodium, calcium, and aluminum in the bentonite. The bentonite acts as a viscosifier. The viscosifier is an additive of the drilling fluid suspension that increases the viscosity of the drilling fluid suspension. In some embodiments, the bentonite may be substituted by other viscosifiers that may include, but are not limited to, sodium carbonate (soda ash), bauxite, dolomite, limestone, calcite, vaterite, aragonite, magnesite, taconite, gypsum, quartz, marble, hematite, limonite, magnetite, andesite, garnet, basalt, dacite, nesosilicates or orthosilicates, sorosilicates, cyclosilicates, inosilicates, phyllosilicates, tectosilicates, kaolins, montmorillonite, fullers earth, halloysite, and the like. In some embodiments, the viscosifier may further include a natural polymer, such as hydroxyethyl cellulose (HEC), carboxymethylcellulose, polyanionic cellulose (PAC), and the like, or a synthetic polymer, such as poly(diallyl amine), diallyl ketone, diallyl amine, styryl sulfonate, vinyl lactam, laponite, polygorskites (such as attapulgite, sepiolite), and the like, and combinations thereof. In some embodiments, the viscosifier may be a corn starch. The XC-polymer acts as a thickening agent. The XC-polymer may be substituted by other thickening agents such as xanthan gum, guar gum, glycol, the like, and combinations thereof.

The starch acts as a fluid loss prevention agent. The fluid loss prevention agent is an additive of the drilling fluid suspension that controls loss of the drilling fluid suspension when injected into the subterranean geological formation. In some embodiments, the drilling fluid suspension may include multiple fluid loss prevention agents depending on the customized need of a user. In some embodiments, other fluid loss prevention agents such as, polysaccharides, silica flour, gas bubbles (energized fluid or foam), benzoic acid, soaps, resin particulates, relative permeability modifiers, degradable gel particulates, hydrocarbons dispersed in fluid, one or more immiscible fluids, the like, and a combination thereof may be used as well. In some embodiments, a gelling agent, such as a carbomer, a carrageenan, a chitosan, a gelatin, a pectin, a poloxamer, a poly(ethylene), and the like, may be used to impart viscosity and/or stabilize the drilling fluid suspension. In some embodiments, a viscosifier, such as a hydroxyethyl cellulose polymer, a drilling polymer, a resonated polymer, a polyacrylate polymer, and the like, may be used to increase a carry capacity of the drilling fluid suspension. In some embodiments, a dispersion agent may be included in the drilling fluid suspension to reduce cohesive forces between particles of the same type and enhance dispersion of the ZIF-67.

The hydroxide acts as a pH-adjusting agent, also referred to as the buffer. The pH-adjusting agent may include an alkali metal base. In some embodiments, the alkali metal base may include, but is not limited to, potassium hydroxide, lithium hydroxide, rubidium hydroxide, cesium hydroxide, and sodium hydroxide. In a preferred embodiment, the alkali metal base is potassium hydroxide. In some embodiments, the pH adjusting agent may include, but is not limited to, monosodium phosphate, disodium phosphate, sodium tripolyphosphate. In some embodiments, the pH of the drilling fluid suspension is acidic or neutral. In a preferred embodiment, the pH of the drilling fluid suspension is basic, with pH ranging from 7 to 14, preferably 8 to 14, preferably 9 to 14, more preferably 10 to 14, and yet more preferably 11 to 13.

The carbonate acts as a weighting agent. The weighting agent is an agent that increases the overall density of the drilling fluid suspension in order to provide a sufficient bottom-hole pressure to prevent an unwanted influx of formation fluids. In some embodiments, the weighting agent may include but is not limited to, calcium carbonate, sodium sulfate, hematite, siderite, ilmenite, the like, and a combination thereof.

The drilling fluid suspension may include an alkali metal halide salt. In some embodiments, the alkali metal halide salt is potassium chloride. In some embodiments, the alkali metal halide salt may include, but is not limited to, sodium chloride, lithium chloride, rubidium chloride, and cesium chloride.

In some embodiments, the drilling fluid suspension may also include a deflocculant. Deflocculant is an additive of the drilling fluid suspension that prevents a colloid from coming out of suspension or slurries. The deflocculant may include, but is not limited to, an anionic polyelectrolyte, for example, acrylates, polyphosphates, lignosulfonates (LS), or tannic acid derivatives, for example, quebracho, the like, and a combination thereof.

In some embodiments, the drilling fluid suspension may also include a lubricant. The lubricant may include, but is not limited to, polyalpha-olefin (PAO), synthetic esters, polyalkylene glycols (PAG), phosphate esters, alkylated naphthalenes (AN), silicate esters, ionic fluids, multiply alkylated cyclopentanes (MAC), the like, and a combination thereof.

In some embodiments, the drilling fluid suspension may also include a crosslinker. The crosslinker is an additive of the drilling fluid suspension that can react with multiple-strand polymers to couple molecules together, thereby creating a highly viscous fluid, with a controllable viscosity. The crosslinker may include, but is not limited to, metallic salts, such as salts of aluminium, iron, boron, titanium, chromium, zirconium, and the like, and/or organic crosslinkers, such as polyethylene amides and formaldehyde, the like, and a combination thereof.

In some embodiments, the drilling fluid suspension may also include a breaker. The breaker is an additive of the drilling fluid suspension that provides a desired viscosity reduction in a specified period. The breaker may include, but is not limited to, oxidizing agents, such as sodium chlorites, sodium bromates, hypochlorites, perborate, persulfates, peroxides, enzymes, the like, and a combination thereof.

In some embodiments, the drilling fluid suspension may include a biocide. The biocide is an additive of the drilling fluid suspension that may kill microorganisms present in the drilling fluid suspension. The biocide may include, but is not limited to, phenoxyethanol, ethylhexyl glycerine, benzyl alcohol, methyl chloroisothiazolinone, methyl isothiazolinone, methyl paraben, ethyl paraben, propylene glycol, bronopol, benzoic acid, imidazolinidyl urea, 2,2-dibromo-3-nitrilopropionamide, 2-bromo-2-nitro-1,3-propanedial, the like, and a combination thereof.

The drilling fluid suspension may also include a corrosion-inhibiting agent. The corrosion inhibiting agent is a chemical compound that decreases the corrosion rate of a material, more preferably, a metal or an alloy, that meets the drilling fluid suspension. In some embodiments, the corrosion inhibiting agent may include, but is not limited to, imidazolines, and amido amines. In some embodiments, the corrosion inhibiting agent may include, but is not limited to, oxides, sulfides, halides, nitrates, preferably halides, of metallic elements of group IIIa to VIa such as SbBr₃, the like, and a combination thereof.

The drilling fluid suspension may also include an anti-scaling agent. The anti-scaling agent is an additive of the drilling fluid suspension that inhibits the formation and precipitation of crystallized mineral salts that form scale. The anti-scaling agent may include, but is not limited to, phosphonates, acrylic co/ter-polymers, polyacrylic acid (PAA), phosphino poly carboxylic acid (PPCA), phosphate esters, hexamethylene diamine tetrakis (methylene phosphonic acid), diethylene triamine tetra (methylene phosphonic acid), diethylene triamine penta (methylene phosphonic acid) (DETA phosphonate), bis-hexamethylene triamine pentakis (methylene phosphonic acid) (BHMT phosphonate), 1-hydroxyethylidene 1,1-diphosphonate (HEDP phosphonate), polymers of sulfonic acid on a polycarboxylic acid backbone, and the like. In some embodiments, the anti-scaling agent may further include phosphine, sodium hexametaphosphate, sodium tripolyphosphate and other inorganic polyphosphates, hydroxy ethylidene diphosphonic acid, butane-tricarboxylic acid, phosphonates, itaconic acid, 3-allyloxy-2-hydroxy-propionic acid, the like, and a combination thereof. In some embodiments, the drilling fluid suspension may include metal sulfide scale removal agents, such as hydrochloric acid.

The drilling fluid suspension may also include a chelating agent. The chelating agent may include, but is not limited to, dimercaprol (2,3-dimercapto-1-propanol), diethylenetriaminepentaacetic acid (DTPA), hydroxyethylenediaminetriacetic acid (HEDTA), ethylenediaminetetraacetic acid (EDTA), the like, and a combination thereof. Concentration of components of the drilling fluid suspension may be varied to impart desired characteristics of the drilling fluid suspension.

At step 54, the method 50 includes injecting the drilling fluid suspension in the subterranean geological formation. In some embodiments, the drilling fluid is injected into the subterranean geological formation through a wellbore. In some embodiments, driving a drill bit to form a wellbore in the subterranean geological formation may lead to the production of a formation fluid. In some embodiments, the formation fluid may be a sour gas and a sour crude oil. The sour gas is a natural gas including an amount of the hydrogen sulfide. In some embodiments, the formation fluid may include natural gas (i.e., majority methane), hydrocarbon or non-hydrocarbon gases (including condensable and non-condensable gases), light hydrocarbon liquids, heavy hydrocarbon liquids, rock, oil shale, bitumen, oil sands, tar, coal, water, the like, and a combination thereof. Further, the non-condensable gases may include, but are not limited to hydrogen, carbon monoxide, carbon dioxide, methane, and the like. In some other embodiments, the formation fluid may be in the form of a gaseous fluid, a liquid, or a double-phase fluid. In some embodiments, the formation fluid includes hydrogen sulfide. Microorganisms, such as sulfate reducing bacteria, may generate the hydrogen sulfide in gas and oil reservoirs. In some embodiments, some other method used or known in the art may lead to the formation of the hydrogen sulfide in the wellbore. The subterranean geological formation includes one or more hydrocarbons similar to the hydrocarbons present in the formation fluid.

At step 56, the method 50 includes circulating the drilling fluid suspension in the subterranean geological formation and forming a water-based mud (WBM). Once the drilling fluid suspension is injected in the reservoir, it mixes with sub-surface fluid and circulates in the subterranean geological formation to form the WBM. The WBMs have a high corrosive nature, an increased fluid loss, and lower penetration rates. In some embodiments, the water-based mud may have a density of 5 to 15 parts per gallon (ppg), preferably 6 to 13 ppg, preferably 7 to 11 ppg, more preferably 8 to 10 ppg, and yet more preferably about 9 ppg.

At step 58, the method 50 includes scavenging hydrogen sulfide from the subterranean geological formation. In some embodiments, the concentration of the cobalt-imidazolate ZIF-67 material may be adjusted according to the hydrogen sulfide amount that may be encountered during the wellbore drilling. The hydrogen sulfide reacts with the cobalt-imidazolate ZIF-67 material during scavenging, thereby converting hydrogen sulfide into a hydrosulfide. In some embodiments, the hydrogen sulfide may react with the cobalt-imidazolate ZIF-67 material during scavenging to form elemental sulfur and an insoluble sulfide. In some embodiments, the hydrosulfide is bound to uncoordinated open metal cobalt(II) sites and basic nitrogen sites in the cobalt-imidazolate ZIF-67 material.

In some embodiments, the H₂S scavenging performance of cobalt-imidazolate ZIF-67 material in the drilling fluid suspension may be evaluated by flowing hydrogen sulfide gas into the drilling fluid suspension. In some embodiments, the hydrogen sulfide gas is seeded in methane at a concentration of 100 parts per million volume (ppmv). In some embodiments, the flowing of hydrogen sulfide gas is done at a rate of 50 to 150 mL/min, preferably 80 to 120 mL/min, more preferably 90 to 110 mL/min, and yet more preferably about 100 mL/min. The breakthrough time for the hydrogen sulfide in the presence of the drilling fluid suspension is 20 to 30 times, preferably 22 to 28 times, more preferably 24 to 25 times, and yet more preferably about 24.4 times greater compared to a breakthrough time for the hydrogen sulfide in the presence of the drilling fluid suspension without the cobalt-imidazolate ZIF-67 material. The saturation time for the hydrogen sulfide in the presence of the drilling fluid suspension is 2 to 6 times, preferably 2 to 5 times, more preferably 3 to 4 times, and yet more preferably about 3.5 times greater compared to a saturation time for the hydrogen sulfide in the presence of the drilling fluid suspension without the cobalt-imidazolate ZIF-67 material.

The breakthrough capacity for the hydrogen sulfide in the presence of the drilling fluid suspension is 20 to 30 times, preferably 22 to 27 times, more preferably 23 to 25 times, and yet more preferably about 24.2 times greater compared to a breakthrough capacity for the hydrogen sulfide in the presence of the drilling fluid suspension without the cobalt-imidazolate ZIF-67 material. In some embodiments, a saturation capacity for the hydrogen sulfide in the presence of the drilling fluid suspension is 4 to 8 times, preferably 4 to 7 times, more preferably 5 to 6 times, and yet more preferably about 5.9 times greater compared to a saturation capacity for the hydrogen sulfide in the presence of the drilling fluid suspension without the cobalt-imidazolate ZIF-67 material.

The plastic viscosity of the drilling fluid suspension is 1.1 to 1.5 times, preferably 1.2 to 1.4 times, more preferably 1.25 to 1.35 times, and yet more preferably about 1.3 times greater compared to the plastic viscosity of the drilling fluid suspension without the cobalt-imidazolate ZIF-67 material. The apparent viscosity of the drilling fluid suspension is 1.1 to 1.6 times, preferably 1.2 to 1.5 times, and more preferably 1.3 to 1.4 times greater compared to an apparent viscosity of the drilling fluid suspension without the cobalt-imidazolate ZIF-67 material.

The gel strength of the drilling fluid suspension at a time of 10 seconds is 2 to 5 times, preferably 3 to 4 times, and more preferably 3.8 times greater compared to a gel strength of the drilling fluid suspension without the cobalt-imidazolate ZIF-67 material at a time of 10 seconds. In some embodiments, the gel strength of the drilling fluid suspension at a time of 10 minutes is 1.5 to 3.5 times, preferably 2 to 3 times, and more preferably 2.2 to 2.8 times greater compared to the gel strength of the drilling fluid suspension without the cobalt-imidazolate ZIF-67 material at a time of 10 minutes.

### EXAMPLES

The following examples demonstrate the method for removing hydrogen sulfide (H₂S) from a subterranean geological formation. The examples are provided solely for illustration and are not to be construed as limitations of the present disclosure, as many variations thereof are possible without departing from the spirit and scope of the present disclosure.

### Example 1: Materials

All chemicals and additives used in the water-based mud (WBM) formulation and synthesis of the zeolitic imidazolate framework-67 (ZIF-67) nanoparticles (NPs) were of analytical-grade purity or higher. For the ZIF-67 synthesis, cobalt nitrate hexahydrate (purity≥98%, Sigma-Aldrich), 2-methylimidazole (purity≥99%, Sigma-Aldrich), and ammonium hydroxide (28%-30% NH₃, Sigma-Aldrich) were used. For the formulation of the WBM, starch (Millipore), potassium hydroxide (purity≥99.99%, Sigma-Aldrich), calcium carbonate (purity≥98.5%, Sigma-Aldrich), XC-polymer (i.e., xanthan gum, Sigma-Aldrich), and bentonite (Sigma-Aldrich) were used. All materials were used as received without any further purification.

### Example 2: Synthesis of ZIF-67

The ZIF-67 NPs were synthesized by dissolving 0.11 mol of Co(NO₃)₂·6H₂O in 80 milliliters (mL) of distilled water under magnetic stirring for 10 minutes [He, M., Yao, J., Liu, Q., Wang, K., Chen, F., Wang, H., Facile synthesis of zeolitic imidazolate framework-8 from a concentrated aqueous solution. Microporous Mesoporous Mater., 2014, 184, 55-60; and Li, Y., Zhou, K., He, M., Yao, J., Synthesis of ZIF-8 and ZIF-67 using mixed base and their dye adsorption. Microporous Mesoporous Mater., 2016, 234, 287-292, both of which are incorporated herein by references in their entirety]. In another volumetric flask, 0.22 mol of 2-methylimidazole was dissolved in 200 mL of aqueous NH₄OH solution. The 2-methylimidazole solution was then quickly poured into the cobalt nitrate solution, and the resulting mixture was continuously stirred for 30 minutes. The purple suspension formed was centrifuged at 10,000 revolutions per minute (rpm) and washed with distilled water until the supernatant pH dropped to 7. The obtained ZIF-67 NPs were dried overnight at 60° C. Further, ZIF-67 NPs were sieved with a 450 micrometer (m) mesh and stored in tightly closed containers until use.

### Example 3: ZIF-67 Characterization

The crystal structure and phases of the ZIF-67 NPs were confirmed by X-ray diffraction (XRD) analysis. The XRD measurements were conducted with the aid of copper (Cu) radiation at 40 Kilovolts (kV), 30 milliamperes (mA), and scanned over a 2θ range of 5° to 25°. Fourier-transform infrared (FTIR) spectroscopy was used to confirm the functional groups present and ascertain the formation of ZIF-67 NPs. The FTIR spectra were measured over a wavenumber range of 400 to 4000 cm⁻¹ with 32 scans. The nitrogen (N₂) adsorption/desorption isotherms on/from the ZIF-67 NPs were measured at −196° C. within a partial pressure range of 0-1 and analyzed with the Brunauer-Emmette-Teller (BET) equation. The BET measurements revealed textural properties such as specific surface area, pore volume, and pore size of the ZIF-67 NPs. Additionally, thermogravimetric analysis (TGA) measurements were conducted to investigate the thermal stability of the synthesized ZIF-67 NPs. The measurements were performed under nitrogen gas and in the temperature range from 30° C. to 800° C.

### Example 4: WBM Formulation

The drilling mud was prepared by adding various additives at the required proportions to distilled water as the base fluid and mixed at 2400 rpm with the aid of a laboratory mixer. The quantities, mixing order, mixing duration, and purpose of the materials/additives used to prepare the WBM are listed in Table 1. The additives were specifically used to control pH, viscosity, filtration loss, gel strength, and filter cake formation. Bentonite is first dispersed in distilled water (i.e., the base fluid), and then filtration loss agents (XC-polymer and starch) are added. Furthermore, the pH control agent, potassium hydroxide (KOH), is added, followed by the addition of the weighting agent, calcium carbonate. The H₂S scavenger ZIF-67 was then added at the required concentrations.

TABLE 1
Composition of the base and ZIF-67-based WBM

| Mixing | Mixing | | | | |
|---|---|---|---|---|---|
| sequence | duration | Additives | Function | Quantities | |
| 1 | — | Distilled water | Base fluid | 350.0 | mL |
| 2 | 30 minutes | Bentonite | Viscosifier | 20.0 | g |
| 3 | 30 minutes | XC-polymer | Fluid loss control and viscosifier | 0.2 | g |
| 4 | 30 minutes | Starch | Fluid loss control | 6.0 | g |
| 5 | 10 minutes | Potassium | pH control | 0.5 | g |
| | | hydroxide | | | |
| 6 | 30 minutes | Calcium | Weighting agent | 30.0 | g |

| | | | | |
|---|---|---|---|---|
| | | carbonate | | |
| 7 | 20 minutes | ZIF-67 | H₂S scavenger | 0.1-1.0 wt. % |

### Example 5: WBM Rheology and Filtration Loss Measurements

The rheological parameters such as plastic viscosity (PV), apparent viscosity (AV), yield point (YP), and 10 second and 10 minute gel strengths were determined according to the American Petroleum Institute (API) standards (API RP 13B-2) [Perween, S., Thakur, N. K., Beg, M., Sharma, S., Ranjan, A., Enhancing the properties of water based drilling fluid using bismuth ferrite nanoparticles, Colloids Surf A Physicochem. Eng. Asp., 2019, 561, 165-177; and Zhong, H., Shen, G., Qiu, Z., Lin, Y., Fan, L., Xing, X., Li, J., Minimizing the HTHP filtration loss of oil-based drilling fluid with swellable polymer microspheres, J. Pet. Sci. Eng., 2019, 172, 411-424, both of which are incorporated herein by references in their entirety]. The measurements were conducted with a viscometer (Model M3600, Grace Instrument) at 120° F. and atmospheric pressure. The Bingham plastic model was adopted to calculate the rheological parameters, such as PV, AV, and YP, based on the dial readings measured at 600 and 300 rpm using equations 1, 2, and 3. The 10 second and 10 minute gel strengths were measured at a low shear rate of 3 rpm after subjecting the drilling fluids to static periods of 10 seconds and 10 minutes, respectively.

$$PV ( cP ) = {ϕ}_{600 rpm} - {ϕ}_{300 rpm} \qquad ( 1 )$$

$$YP ( lb / 100 {ft}^{2} ) = {ϕ}_{300 rpm} - PV \qquad ( 2 )$$

$$AV ( cP ) = {ϕ}_{600 rpm} / 2 \qquad ( 3 )$$

where ϕ₆₀₀ᵣₚₘ and ϕ₃₀₀ᵣₚₘ are dial readings at 600 rpm and 300 rpm, respectively.

Additionally, an API filter press apparatus was used to perform the static filtration tests to investigate the fluid loss performance of the WBMs. The API procedure was followed, with the apparatus operating at 100 psi and the tests conducted at ambient temperature. Filtration volumes were recorded every minute over a 30 minute period, and the thickness of the mud cakes was measured.

### Example 6: H₂S Scavenging

The H₂S scavenging tests were conducted to determine the H₂S scavenging capacities of the WBM and the ZIF-67-based WBM. The tests were carried out at room temperature and atmospheric pressure. The experimental setup utilized for the H₂S test is illustrated in FIG. 1B. In each H₂S scavenging test, 10.0 g of WBM was placed in a bubble column. The inlet of the bubble column was connected to a gas cylinder that contained 100 ppm H₂S (methane balance gas), which served as a continuous H₂S source. The outlet of the bubble column was connected to an H₂S detector with a 0.1 ppm detection limit. A flowmeter was mounted to control the inlet gas flow rate at 100 mL/min throughout the experiment. The outlet concentration of H₂S was continuously monitored and recorded until breakthrough and saturation times were reached during each test. To ensure the credibility of the collected experiment data, the H₂S detector was calibrated before each test. The amounts of H₂S scavenged at breakthrough and saturation times were calculated using equations 4 and 5.

$$Breakthrough capacity ( mg / L ) = ( {Q}_{v} {ρ}_{{H}_{2} s} {\int }_{0}^{{t}_{b}} ( 100 - {C}_{out} ) dt ) / Vf \qquad ( 4 )$$

$$Saturation capacity ( mg / L ) = ( {Q}_{v} {ρ}_{{H}_{2} s} {\int }_{0}^{{t}_{s}} ( 100 - {C}_{out} ) dt ) / Vf \qquad ( 5 )$$

Where Qᵥ is the inlet volumetric gas flow rate (mL/min), ρ_{H}_{₂}_{S} is the density of H₂S (1.391 mg/mL), t_{b} is the breakthrough time (min), tₛ is the saturation time (min), V is the volume of mud (L), f is conversion factor (10⁶), and Cₒᵤₜ is the outlet H₂S concentration in parts per million volume (ppmv), respectively.

### Example 7: Characterization of ZIF-67 NPs

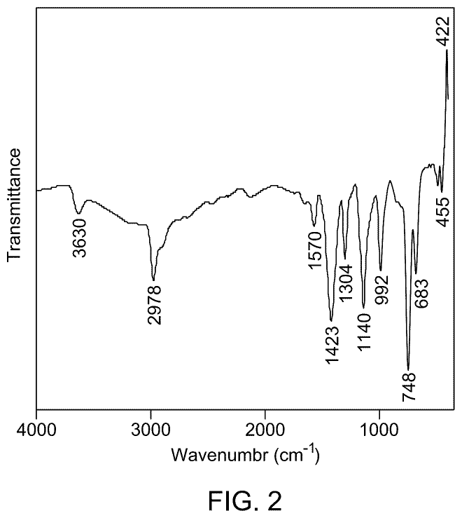

The FTIR analysis was conducted to determine the surface functional groups on the synthesized ZIF-67 NPs. FIG. 2 depicts the FTIR spectrum of ZIF-67 NPs. The 2-methylimidazolate framework exhibited broad and strong absorption peaks between 1500 cm⁻¹ and 600 cm⁻¹ that may be linked to the vibration and bending of the imidazole ring. The peak appearing at 3630 cm⁻¹ may be assigned to the O—H stretching vibration of moisture in the KBr deliquescence or the analyzed ZIF-67 sample [Zhang, Y., Jia, Y., Hou, L., Synthesis of zeolitic imidazolate framework-8 on polyester fiber for PM 2.5 removal, RSC Adv., 2018, 8, 31471-31477, which is incorporated herein by reference in its entirety]. The peak at 2978 cm⁻¹ may be assigned to the aromatic and aliphatic C—H stretching vibration of the methyl group in the imidazole ring [Kaur, H., Mohanta, G. C., Gupta, V., Kukkar, D., Tyagi, S., Synthesis and characterization of ZIF-8 nanoparticles for controlled release of 6-mercaptopurine drug, J. Drug Deliv. Sci. Technol., 2017, 41, 106-112, which is incorporated herein by reference in its entirety]. Further, the peak at 1576 cm⁻¹ is attributed to the presence of C═N stretching vibration in the imidazole ring. The stretching and bending vibrations of the C—N in the aromatic imidazole ring are characterized by the peaks 1146 cm⁻¹ and 995 cm⁻¹, respectively. The absorption peak at 683 cm⁻¹ is attributed to the aromatic sp² C—H bending vibration. The peak at 455 cm⁻¹ to 422 cm⁻¹ is assigned to the Co—N bond stretching vibration of the ZIF-67 nanocrystals. Therefore, FTIR results indicate the formation of ZIF-67.

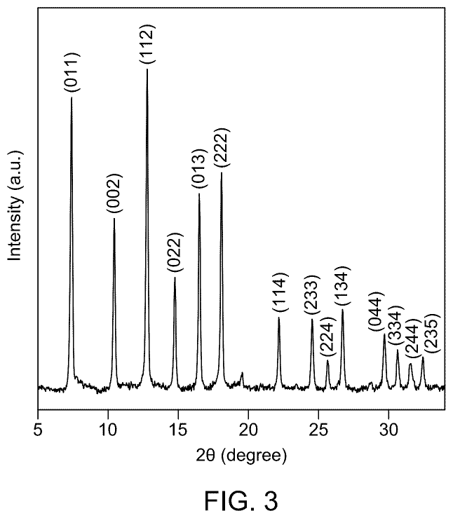

The crystal structure and phase composition of the synthesized ZIF-67 NPs were examined by XRD. As illustrated in FIG. 3, the XRD pattern exhibited well-defined peaks at 2θ of 7.41°, 10.44°, 12.78°, 14.76°, 16.53°, 18.09°, 22.17°, 24.54°, 25.65°, 26.70°, 29.70°, 30.63°, 31.56°, and 32.490 which correspond to the (011), (002), (112), (022), (013), (222), (114), (233), (224), (134), (044), (334), (244), and (235) crystal planes, respectively. Notably, the intensities of the peaks at 2θ of 12.78° and 7.41° attributed to the (112) and (110) planes, respectively, are much stronger than other peaks, illustrating the favourable orientation of the (112) and (110) directions. Also, the sharp diffraction peaks indicate the high crystallinity and purity of the synthesized ZIF-67.

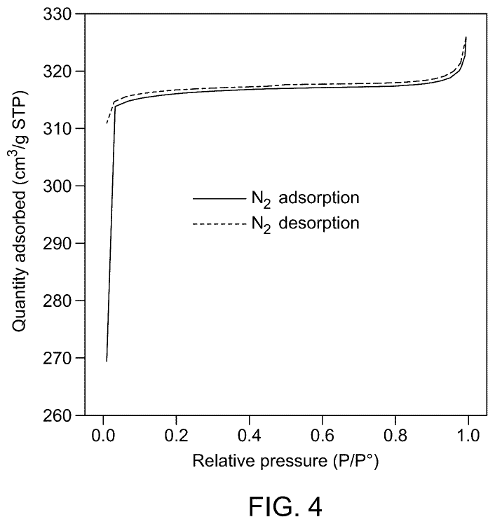

The BET surface area, pore volume, and pore size of the synthesized ZIF-67 were analyzed by the N₂ adsorption-desorption isotherm at 77 Kelvin (K). FIG. 4 illustrates the nitrogen adsorption-desorption isotherm of ZIF-67 NPs. The isotherm shows a characteristic type I adsorption behavior, which is typical for microporous materials due to the steep increase in the N₂ adsorption on ZIF-67 at low relative pressure. The BET surface area was calculated to be 1158 m²/g. The average pore size, specific pore volume, and average particle size based on the adsorption/desorption isotherm were estimated to be 1.71 nm, 0.495 cm³/g, and 20.7 nm, respectively.

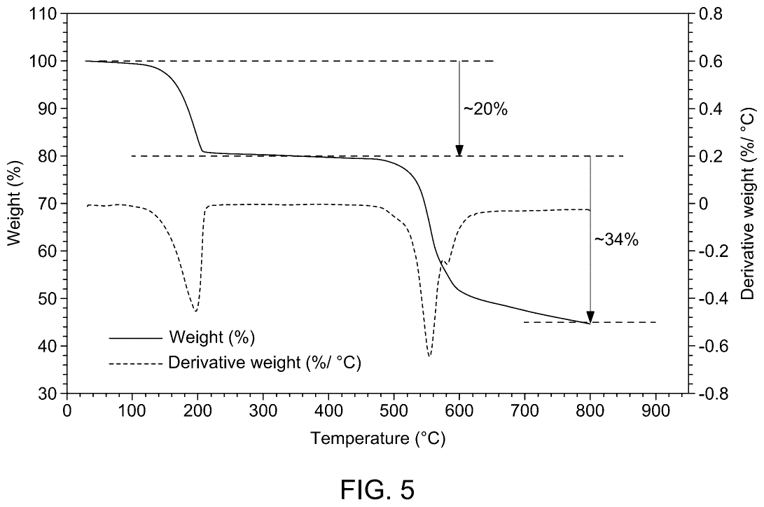

Further, the thermal stability of the prepared ZIF-67 NPs was investigated by thermogravimetric analysis, and the results are depicted in FIG. 5. The synthesized ZIF-67 NPs show an initial weight loss of only about 20% up to a temperature of about 200° C., which corresponds to the removal of bound water moisture and other guest molecules. No further weight loss was observed upon increasing the temperature to about 500° C. Above 500° C., the framework of ZIF-67 collapses, and the organic linker, 2-methylimidazole, decomposes, resulting in about 34% weight loss. Nonetheless, the TGA result presented in FIG. 5 indicates that the prepared ZIF-67 material is thermally stable up to about 500° C. This excellent thermal stability suggests its suitability for drilling applications and H₂S scavenging since the maximum temperature encountered during drilling operations is below 500° C.

### Example 8: Results of H₂S Scavenging

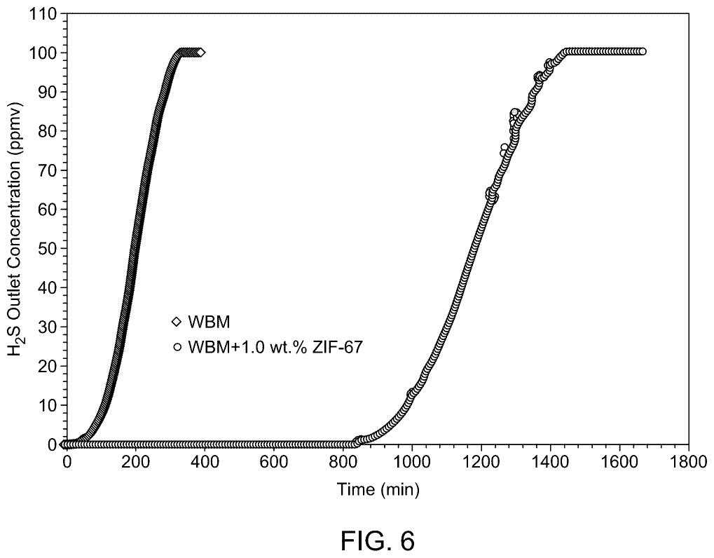

The H₂S scavenging performance of the base and the ZIF-67-containing drilling fluids were evaluated in a bubble column under continuous flow of the sour gas (100 ppmv H₂S in methane). The obtained H₂S breakthrough curves are depicted in FIG. 6. The corresponding calculated H₂S scavenging capacities are given in Table 2. The selected formulations for the H₂S scavenging test are the base mud without any scavenger and the base mud with 1 wt. % ZIF-67 NPs. The base drilling mud exhibited a very low scavenging capacity, whereas the ZIF-67-based mud showed a remarkable H₂S scavenging performance. The breakthrough time of the base mud was 34.5 minutes, corresponding to 52.3 mg H₂S/L scavenging capacity. At saturation, the total amount of H₂S scavenged by the base mud was 294.6 mg/L. The observed scavenging capacities of the base mud may be attributed to free metal ions and the solubility of H₂S in the fluid. As illustrated in FIG. 6, the H₂S scavenging capacities of the ZIF-67-based mud are several folds higher than those of the base mud. Specifically, a breakthrough time of 842 minutes, corresponding to 1259.8 mg H₂S/L scavenging capacity, was recorded in the presence of ZIF-67 NPs. The saturation time and the H₂S capacity scavenged at saturation were 1440 min and 1758.1 mg H₂S/L, respectively.

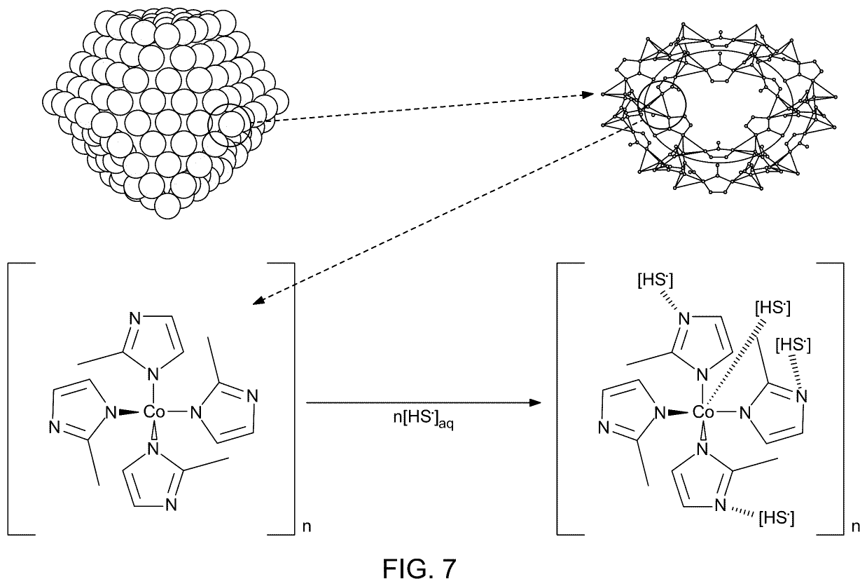

Hydrogen sulfide under aqueous conditions can exist as either H₂S, HS⁻, or S²⁻ depending on the pH of the medium [Holmer, M. and Hasler-Sheetal, H., Sulphide intrusion in seagrasses assessed by stable sulfur isotopes—a synthesis of current results, Front. Mar. Sci., 2014, 1, which is incorporated herein by reference in its entirety]. The pH of the various drilling fluid formulations prepared was maintained between 11 and 11.5. The dominant dissolved species of H₂S present in the drilling muds upon the bubbling of the sour gas at the given pH are HS⁻ (≥95%) and S²⁻ (≤5%). The H₂S and the dissolved HS⁻ fraction are actively scavenged by the uncoordinated open metal Co(II) sites and basic sites originating from the N—H group on the imidazole ring as depicted in FIG. 7. Further, based on the high BET surface area of the ZIF-67 NPs, there is a plurality of polar sites which further accounted for the high scavenging capacity towards H₂S.

TABLE 2
breakthrough time, breakthrough capacity, saturation
time, and saturation capacity of drilling muds.

| Parameters | WBM | WBM + 1 wt. % ZIF-67 |
|---|---|---|
| Breakthrough time (min) | 34.5 | 842 |
| Saturation time (min) | 325 | 1440 |
| Breakthrough capacity (mg/g) | — | 117.2 |
| Saturation capacity (mg/g) | — | 163.6 |
| Breakthrough capacity (mg/L) | 52.3 | 1259.8 |
| Saturation capacity (mg/L) | 294.6 | 1758.1 |
| Breakthrough capacity (g/barrel) | 8.3 | 200.3 |
| Saturation capacity (g/barrel) | 46.8 | 279.5 |

### Example 9: Rheological Properties of Base and ZIF-67 Base WBM

Table 2 and FIG. 6 show that the ZIF-67 NPs exhibited excellent H₂S scavenging performance; however, besides the H₂S scavenging performance, adding a scavenger should not compromise the mud flowability and rheology. To evaluate the impact of the ZIF-67 NPs on the rheological properties of the mud, a series of mud formulations with varying amounts of ZIF-67 (0 wt. %, 0.05 wt. %, 0.25 wt. %, 0.5 wt. %, 0.75 wt. %, and 1 wt. %) were prepared. Rheological parameters, including PV, YP, AV, and gel strengths (10 seconds and 10 minutes), were measured. These rheological properties depend on the physical properties of the additives, their interactions within the base fluid, and their concentration.

### Example 10: Effect of ZIF-67 NPs Addition on PV and AV

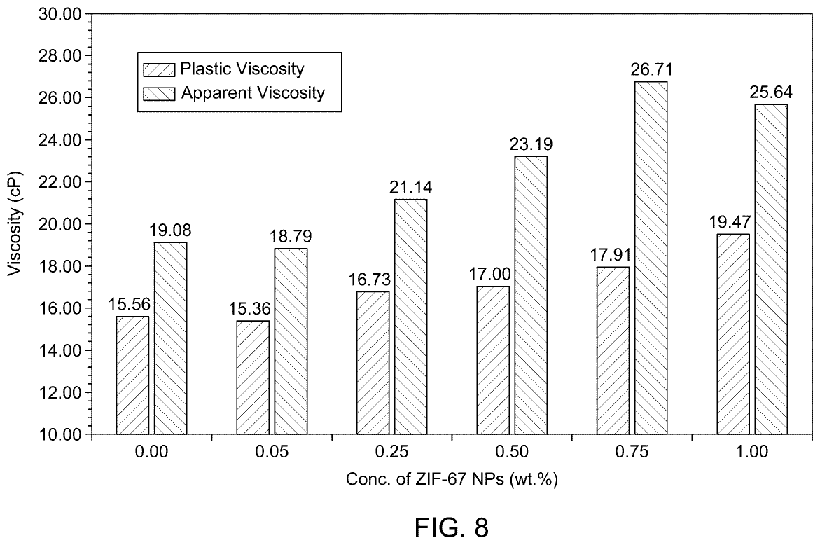

PV is one of the rheological parameters for evaluating the viscosity of drilling mud systems at an infinite shear rate based on the Bingham model [Mohanty, U. S., Aftab, A., Awan, F. U. R., Ali, M., Yekeen, N., Keshavarz, A., Iglauer, S., Toward improvement of water-based drilling mud via zirconia nanoparticle/APIbentonite, Material. Energy & Fuels, 2022, 36, 12116-12125, which is incorporated herein by reference in its entirety]. PV quantifies the flow resistance of drilling muds caused by mechanical friction between solid particles in the mud [Ahasan, M. H., Alvi, Alahi, Md, F., Ahmed, N., Alam, MdS., An investigation of the effects of synthesized zinc oxide nanoparticles on the properties of water-based drilling fluid, Petroleum Research, 2022, 7, 131-137, which is incorporated herein]. Higher magnitudes of PV indicate a correspondingly higher resistance and particulate frictions within the drilling mud, which is uneconomical, increases the power required for circulation, and decreases the rate of penetration (ROP). Further, PV values below the specified ranges are deleterious to fluid loss, increase sagging of cuttings, and reduce hole cleaning efficiency. For successful and continuous recirculation of drilling mud, the PV should be maintained within the specified range to maintain the hydrostatic pressure, reduce energy requirements for pumping, prevent settling of cuttings, maintain wellbore stability, and enhance the drilling rate. FIG. 8 depicts the PV and AV of the WBM with different ZIF-67 contents. As can be seen from FIG. 8, the plastic viscosity increases with increasing NPs concentration in the mud. The base mud had a PV of 15.56 cP. The incorporation of the NPs result in an increase in solid content and a gradual increase in friction between the mud particles, causing increased plastic viscosity; however, at 0.05 wt. % ZIF-67, the plastic viscosity drops slightly by 1.29%. This slight reduction may be due to the initial disruption of the gel formation within the drilling mud. Furthermore, the ZIF-67 NPs at such a low concentration in the mud act as a ball bearing between the larger particles present, thereby reducing inter-particulate friction. The highest plastic viscosity of 19.47 cP is measured at 1 wt. % ZIF-67. At this ZIF-67 content, PV is far from the maximum recommended limit, as shown in Table 3.

The apparent viscosity (i.e., the ratio of shear strain to shear stress) is referred to as the effective viscosity of drilling mud when examined at a finite shear rate. According to the Bingham model, it is one-half of the dial reading at 600 rpm of shear strain. As depicted in FIG. 8, the base mud has an apparent viscosity of 19.08 cP. At 0.05 wt. % ZIF-67, the apparent viscosity is marginally reduced by about 1.52%, likely due to decreased particulate friction, ball bearing effect, and gel disruption. The subsequent increase in the NPs resulted in a steady increase in the apparent viscosity up to a maximum value of 26.71 cP at 0.75 wt. % ZIF-67 NPs in the mud. A reduction of the apparent viscosity by about 4.0% was observed upon the further increase of the ZIF-67 NPs to 1 wt. %. Interestingly, incorporating the ZIF-67 NPs had no adverse effect on the plastic and apparent viscosities of the drilling mud. All of the measured viscosities for the ZIF-67-based muds are within the recommended range, as shown in Table 3. Usually, increasing the solid content increases a drilling mud viscosity; however, due to ionic and particulate interactions of the mud solids and the physical properties of NPs, such as particle size, density, and surface charge, this is not always observed, as seen by the slight decrease of the AV at 1 wt. % NPs content.

### Example 11: Effect of ZIF-67-NPs on the Yield Point (YP) and Carrying Capacity

The YP of a drilling mud is a measure of the initial resistance of the drilling fluid to flow due to electrochemical interactions. The YP provides an indication of the carrying capacity of drill cuttings to the surface by a given mud. The magnitude of the YP indicates the ability of mud to suspend and circulate cuttings. Relatively lower YP values lead to the sagging of weighing agents and cuttings, whereas excessively high YP increases the power requirement for circulation and affects the ROP.

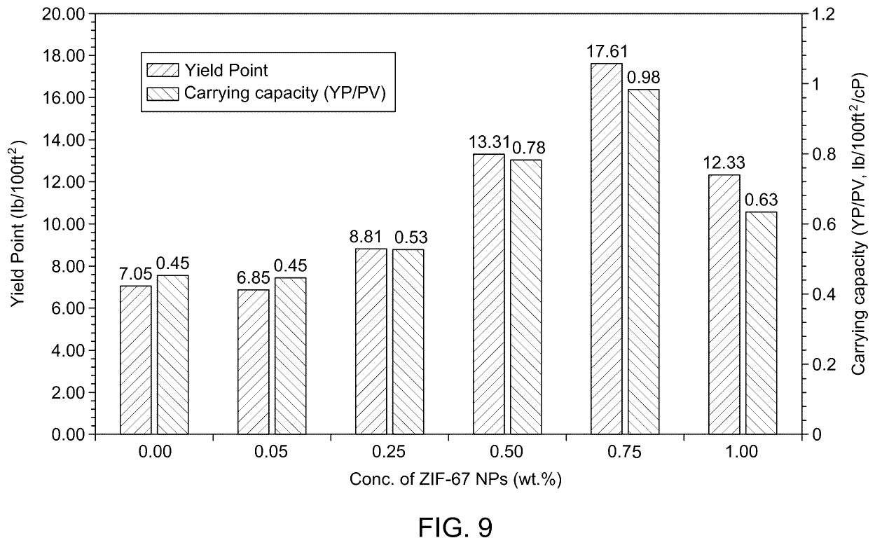

The influence of ZIF-67 NPs on the yield point and carrying capacity is illustrated in FIG. 9. The base mud possesses a YP of 7.05 lb/100 ft², while the lowest and highest YP of 6.85 and 17.61 lb/100 ft² were measured at 0.05 and 0.75 wt. % ZIF-67 NPs in the mud, respectively. The reduction in the YP of the base mud by 2.84% was observed with the addition of 0.05 wt. % ZIF-67 NPs to the base mud. The YP values increased progressively from 6.85 to 17.61 lb/100 ft² after increasing the ZIF-67 NPs concentration from 0.05 to 0.75 wt. %. A subsequent increase in the ZIF-67 NP concentration from 0.75 to 1 wt. % caused a reduction in YP by about 30% (12.33 lb/100 ft²). The observed decrease in YP on the addition of 1 wt. % ZIF-67 NPs may be attributed to the decrease of the total electrostatic potential of the drilling mud due to the agglomeration of ZIF-67 NPs. The drop at 1 wt. % ZIF-67 NPs may not compromise the hole cleaning and wellbore stability of the ZIF-67-based mud since the result falls within the specified range shown in Table 3. Interestingly, the results have shown that ZIF-67 NPs may be utilized to improve the YP and enhance the hole-cleaning efficiency of water-based drilling fluids besides their role as H₂S scavengers.

Another rheological property related to YP and PV is the mud-carrying capacity, defined as the ratio of YP/PV. As depicted in FIG. 9, the carrying capacity exhibited a similar trend to that observed for the yield point at various ZIF-67 NPs concentrations. This is usually the case since both parameters indicate the hole-cleaning ability of drilling fluids. Interestingly, the addition of the ZIF-67 NPs increased the carrying capacity of the drilling fluid, which shows the multiple benefits of incorporating ZIF-67 in drilling fluids, such as enhancement of H₂S scavenging, enhanced yield point, and improved carrying capacity, among others.

TABLE 3
Recommended rheological properties for water-based drilling muds

| Rheological parameters | Specifications |
|---|---|
| Plastic viscosity (PV) (cP) | 8-35 |
| Yield point (YP) (lb/100 ft²) | 5-50 |
| 10 second gel point (lb/100 ft²) | <15 |
| 10 minute gel point (lb/100 ft²) | <35 |
| API fluid loss (mL) (lb/100 ft²) | <15 |

### Example 12: Effects of ZIF-67 NPs on Gel Strength

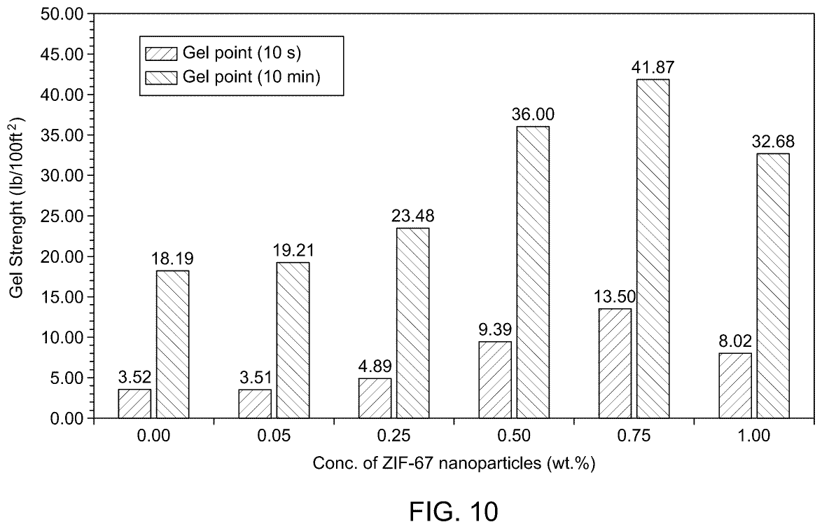

The gel strength is another rheological parameter correlated to the mud's ability to suspend drill cutting and the mud solids under static conditions when there is a cease of mud circulation. It measures intraparticle electrochemical interactions in the drilling fluid under non-flow conditions measured at 10 seconds and 10 minutes, respectively. This rheological parameter indicates the drilling mud's ability to suspend drill cuttings and maintain a stable wellhole while also transporting the cuttings to the surface. A gel strength value to minimize the usually excessive circulation pressure is needed to restart drilling mud flow and prevent sagging of drill cuttings. The influence of ZIF-67 NPs on 10 second and 10 minute gel strengths is depicted in FIG. 10. As illustrated in FIG. 10, the gel strength increased upon adding ZIF-67 NPs to the base mud. The 10-minute gel strength at all NP concentrations exceeds the corresponding 10-second gel strength. The base mud had 10 second and 10 minute gel strengths of 3.52 and 18.19 lb/100 ft², respectively. The 10 second and 10 minute gel strength increased with increasing the ZIF-67 NPs concentration until they peaked at 0.75 wt. % ZIF-67 NPs concentration, with respective values of 13.50 and 41.87 lb/100 ft². The 10 second and 10 minute gel strengths were reduced to 8.02 and 32.68 lb/100 ft² on the further increase of ZIF-67 NPs to 1 wt. %. This occurrence is due to agglomeration at 1 wt. % ZIF-67 NPs concentration, as discussed earlier. The observed increase of the gel strength (10 seconds and 10 minutes) over the range of 0.05-0.75 wt. % ZIF-67 NPs concentration may be due to the strengthening of the gel structure and increase in electrostatic interactions within the mud upon addition of ZIF-67 NPs.

### Example 13: Effects of ZIF-67 NPs on the API Filtration Properties

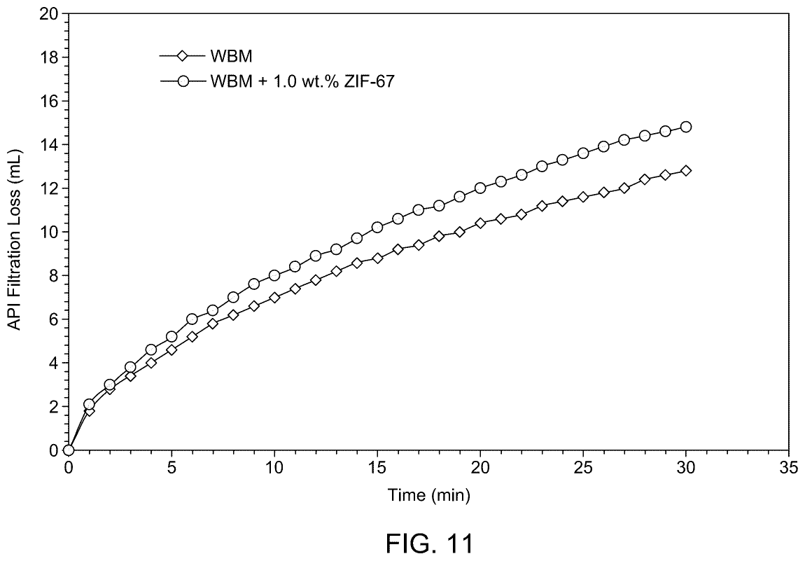

The filtration properties of drilling fluids, such as API fluid loss and API filter cake thickness, are parameters for evaluating the wellbore stability of the utilized mud during drilling operations. The API fluid loss signifies the dischargeable filtrate volume of the drilling fluid when subjected to 100 psi pressure differential and ambient temperature conditions over 30 minutes. According to the API specifications, the fluid loss may not exceed the recommended value of 15 mL, as seen in Table 3. A high fluid loss volume may compromise the stability of drilling mud and cause excessive formation damage. The filter cake is the deposited layer of the suspended drilling fluid solids during the API fluid loss test. The filter cake thickness measures the amount of solid deposited, which indicates the cake formation in the wellbore across permeable zones during drilling operations. To avoid formation instabilities, excessive fluid loss, and the sticking of the drill string, an impermeable, strong, and thin filter cake is preferred. The recommended thickness of filter cake is less than 3/32 inch. The 30 minute API fluid loss for the base mud and the mud at 1 wt. % ZIF-67 NPs concentration is illustrated in FIG. 11. The base mud had a fluid loss volume of 12.8 mL, whereas the maximum concentration of ZIF-67 NPs in the base mud had a fluid loss volume of 14.8 mL. The fluid loss in both cases is within the API recommended limit, as can be seen from Table 3. Despite the slight increase in the fluid loss upon the addition of the maximum ZIF-67 content into the base drilling mud, the gained benefits from adding ZIF-67 in terms of the increase in the H₂S scavenging capacity and the improvement of some rheological properties outweigh the fluid loss.

Although the API fluid loss volume of drilling fluid is usually thought to reduce in the presence of NPs due to the increase in solid content of the mud, this is not always the case. NPs size also plays a role in the permeability of the deposited solids. Moreover, agglomeration at high NPs concentrations may create layers of permeable cake that may increase the fluid loss volume. The possible increase in the interparticle spacing of the fluid loss control agent due to the presence of ZIF-67 NPs might have slightly decreased the close packing needed to form an impermeable cake. Nonetheless, the API fluid loss volume in the presence of the ZIF-67 NPs is within the recommended API specifications, as mentioned above.

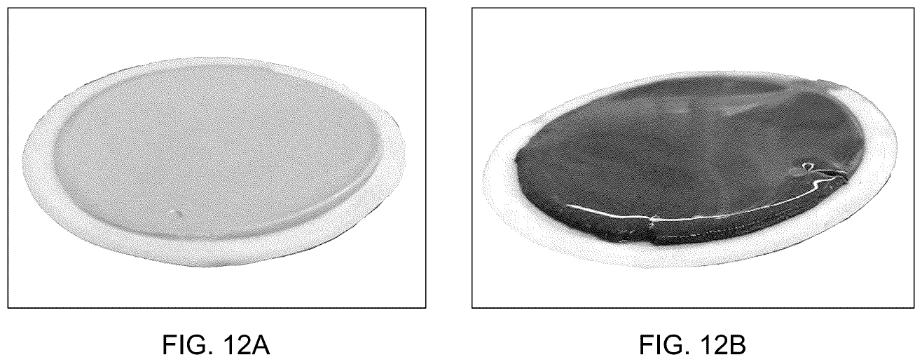

Table 4 and FIGS. 12A-12B illustrate the filter cake thickness and the images of the filter cakes obtained with the base mud and the ZIF-67-based mud, respectively. As shown in Table 4, the base mud had a filter cake thickness of 3/32 inch and the 1 wt. % ZIF-67-based mud had a filter cake thickness of 4/32 inch. The filter cake thickness increased with the addition of the ZIF-67 NPs. The measured filter cake thickness corroborates the magnitudes of the fluid losses, respectively. This marginal increase in the filter cake thickness at the highest ZIF-67 dosage of 1 wt. % used may be due to particle agglomeration; however, this increase in the filter cake thickness did not adversely affect the fluid loss volume. This is indicative that the ZIF-67 NPs may not compromise wellbore stability during drilling operations and may be successfully incorporated into drilling fluids.

TABLE 4
API filter cake thickness and lost volume

| Formulation | Cake thickness (mm) | Lost volume (mL) |
|---|---|---|
| WBM | 2.38 | 12.8 |
| WBM + 1 wt. % ZIF-67 | 3.18 | 14.8 |

### Example 14: Shear Rate-Shear Stress Curve and Rheological Modelling

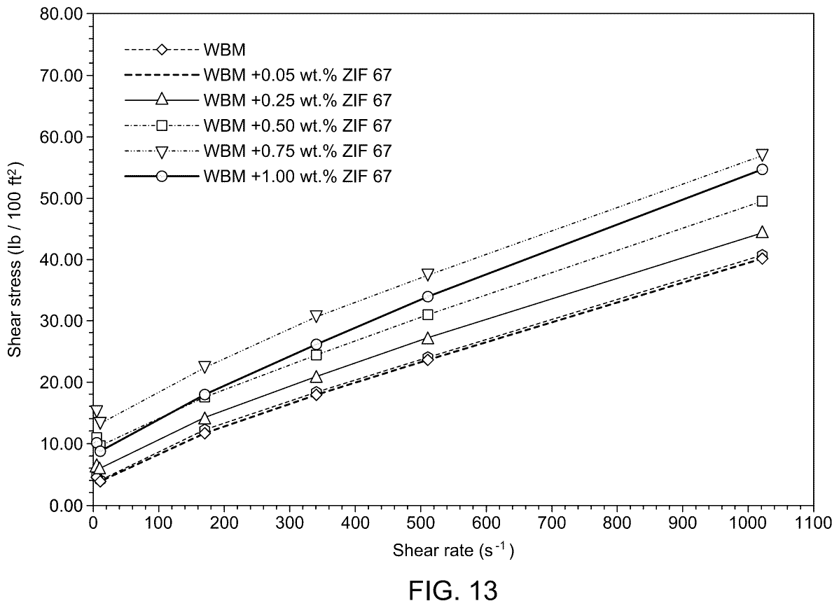

The shear rate-shear stress curve demonstrates the correlation between the shear stress and the shear rate of the drilling fluid. In general, the shear stress describes the force per unit area that the fluid experiences due to its motion, while the shear rate defines the rate at which each layer of the drilling fluid moves relative to another layer. By examining this curve, the behavior of fluid viscosity exhibited and the general rheological behavior, such as Newtonian and non-Newtonian, may be characterized. The shear rate-shear stress curve of the base mud and the scavenger containing mud at the various concentrations is illustrated in FIG. 13. As can be seen from FIG. 13, the addition of ZIF-67 NPs resulted in a progressive increase in the shear stress of the drilling mud, which is due to the increase in the solid content of the drilling mud. Interestingly, the drilling fluid formulation at all NPs concentrations, including the base mud, exhibited non-Newtonian shear thinning behavior, which is desired in drilling fluids. This behavior enhances the mud flowability, reduces pressure or frictional losses during mud circulation, improves hole cleaning, maintains wellbore stability, improves the ROP, reduces differential sticking of the drill string, and provides better drilling rates.

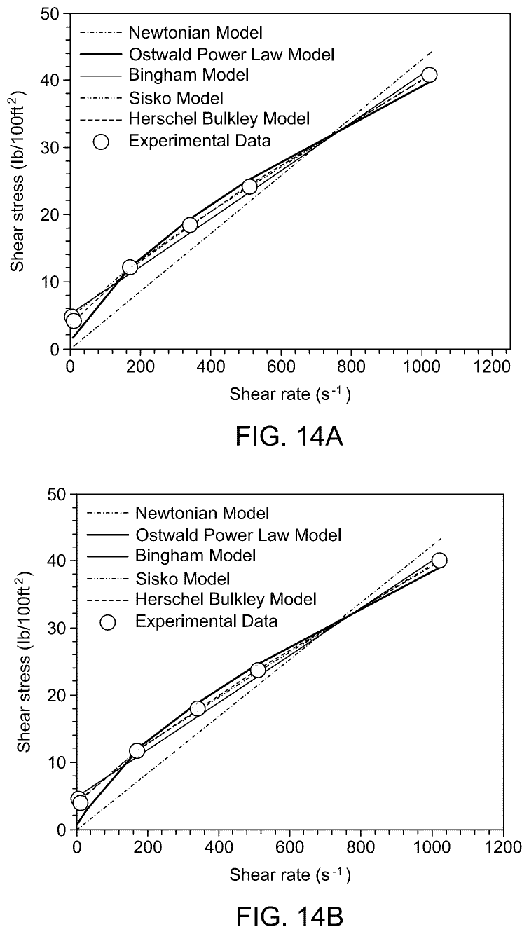

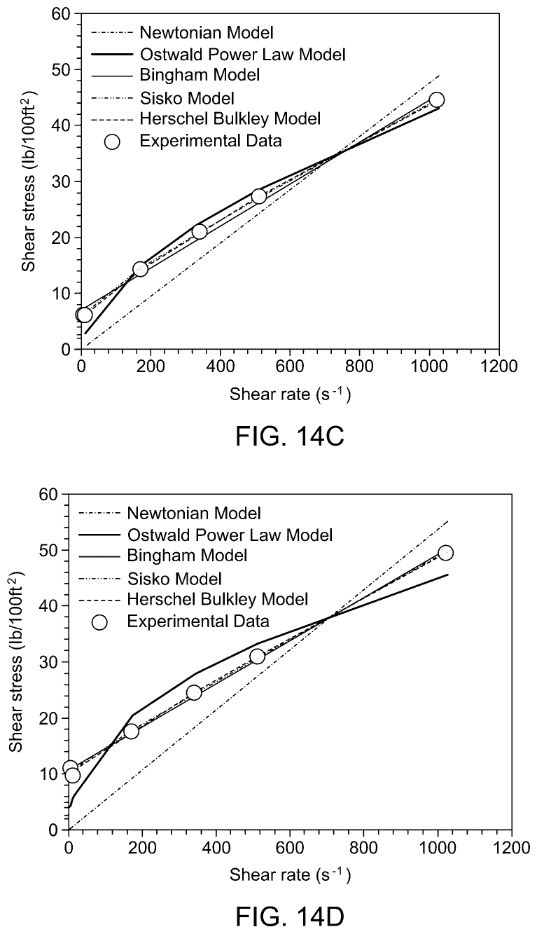

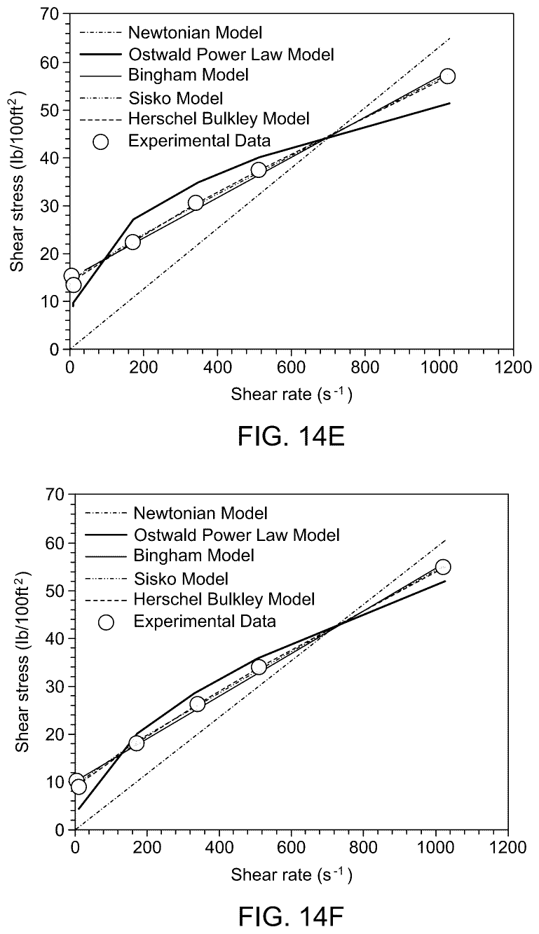

Tables 5A-5E and FIGS. 14A-14F show the results obtained from the rheological modelling of the base mud formulation and those containing various ZIF-67 concentrations. The rheological modelling was conducted using the five most utilized models to identify one that best describes the general behavior of the formulated water-based drilling fluid. These utilized rheological models are the Newtonian model (Equation 6), Bingham model (Equation 7), Herschel Buckley model (Equation 8), Ostwald power law model (Equation 9), and Sisko model (Equation 10), respectively. The aforementioned models and corresponding equations are provided hereinafter.

$$τ = {μ}_{p} γ \qquad ( 6 )$$

$$τ = {τ}_{o} + {μ}_{p} γ \qquad ( 7 )$$

$$τ = {τ}_{o} + {K}_{H} {γ}^{n} \qquad ( 8 )$$

$$τ = {K}_{p} {γ}^{n} \qquad ( 9 )$$

$$τ = {K}_{1} γ + {K}_{2} {γ}^{n} \qquad ( 10 )$$

where τ, ρ, and γ are the shear stress, viscosity, and shear rate, respectively. K₁ is the coefficient of viscosity, K₂, K_{H}, and Kₚ are the consistency coefficients of the Sisko, Herschel Buckley, and Ostwald power law models, respectively. n is the flow index of the fluid (i.e., n<1 represents a pseudoplastic (shear thinning) fluid, n>1 represents a dilatant (shear thickening) fluid, and n=1 corresponds to a Newtonian fluid).

As illustrated in FIG. 14A, the fitting line of the Bingham model (R²=0.994) is close to the measured experimental values of the base mud; however, the rheological models that best tracks the measured values of the base mud are the Herschel Buckley (R²=0.999) and the Sisko model (R²=0.999), since they exhibit a higher coefficient of determination than the Bingham model. Similarly, the rheological models that best describe the various ZIF-67 mud formulations are the Herschel Buckley (R²=0.998-0.999) and the Sisko model (R²=0.997-0.999), since they show a higher R² value than the Bingham model, which had R² ranging from 0.994 up to 0.997, as can be seen from tables 5A-5E and FIGS. 14B-14F. The flow index (n) values of the base mud according to the Herschel Buckley, Ostwald power law, and Sisko models were found to be less than 1, indicating a pseudoplastic behavior of the base drilling mud, as notified in Tables 5A-5E. The coefficient of viscosity (K₁) describes a property that determines the drilling fluid's ability to efficiently remove cuttings from the drilled wells, suspend and transport them to the surface, and maintain wellbore stability. According to the Sisko model (R²=0.999), the base mud had a viscosity coefficient of 3.131 cP. The addition of ZIF-67 NPs increased the coefficient of viscosity of the drilling mud, which indicates that the incorporation of ZIF-67 NPs may be used to enhance the performance of drilling fluids. Similarly, the values of the consistency coefficients (K₂, K_{H}, and Kₚ), which measure the average viscosity of non-Newtonian fluid, increased with increasing ZIF-67 NPs concentration, indicating that the incorporation of ZIF-67 NPs improved the average viscosity of the mud. The trends and rheological behavior of the base mud are closely like the observed trends of the various ZIF-67 mud formulations, which shows that the addition of ZIF-67 NPs did not adversely affect the rheology of the base mud but rather improved it in some instances, as previously discussed.

TABLE 5A
Rheological parameters of water-based drilling fluids containing
ZIF-67 NPs at different concentrations for the Newtonian model

| ZIF-67 (wt. %) | μₚ | R² |
|---|---|---|
| 0 | 0.043 | 0.919 |
| 0.05 | 0.042 | 0.924 |
| 0.25 | 0.048 | 0.884 |
| 0.5 | 0.054 | 0.785 |
| 0.75 | 0.063 | 0.711 |
| 1 | 0.043 | 0.919 |

TABLE 5B
Rheological parameters of water-based drilling fluids containing
ZIF-67 NPs at different concentrations for the Bingham model

| ZIF-67 (wt. %) | μₚ | τₒ | R² |
|---|---|---|---|
| 0 | 0.036 | 5.161 | 0.994 |
| 0.05 | 0.035 | 4.909 | 0.994 |
| 0.25 | 0.038 | 6.846 | 0.994 |
| 0.5 | 0.039 | 10.673 | 0.997 |
| 0.75 | 0.042 | 14.836 | 0.994 |
| 1 | 0.036 | 5.161 | 0.994 |

TABLE 5C
Rheological parameters of water-based drilling fluids containing ZIF-67
NPs at different concentrations for the Herschel Buckley model.

| ZIF-67 (wt. %) | τₒ | K_{H} | n | R² |
|---|---|---|---|---|
| 0 | 3.965 | 0.101 | 0.85 | 0.999 |
| 0.05 | 3.76 | 0.098 | 0.854 | 0.999 |
| 0.25 | 5.449 | 0.117 | 0.838 | 1.000 |
| 0.5 | 9.992 | 0.069 | 0.916 | 0.999 |
| 0.75 | 13.679 | 0.101 | 0.875 | 0.998 |
| 1 | 3.965 | 0.101 | 0.85 | 0.998 |

TABLE 5D
Rheological parameters of water-based drilling
fluids containing ZIF-67 NPs at different concentrations
for the Ostwald power law model.

| ZIF-67 (wt. %) | Kₚ | n | R² |
|---|---|---|---|
| 0 | 0.43 | 0.653 | 0.979 |
| 0.05 | 0.392 | 0.665 | 0.98 |
| 0.25 | 0.731 | 0.588 | 0.969 |
| 0.5 | 2.032 | 0.449 | 0.915 |
| 0.75 | 4.34 | 0.357 | 0.902 |
| 1 | 0.43 | 0.653 | 0.979 |

TABLE 5E
Rheological parameters of water-based drilling fluids containing
ZIF-67 NPs at different concentrations for the Sisko model.

| ZIF-67 (wt. %) | K₂ | K₁ | n | R² |
|---|---|---|---|---|
| 0 | 0.031 | 3.131 | 0.156 | 0.999 |
| 0.05 | 0.031 | 2.966 | 0.157 | 0.999 |
| 0.25 | 0.033 | 4.437 | 0.136 | 1.000 |
| 0.5 | 0.036 | 9.439 | 0.04 | 0.998 |
| 0.75 | 0.039 | 12.796 | 0.048 | 0.997 |
| 1 | 0.031 | 3.131 | 0.156 | 0.999 |

Aspects of the present disclosure are directed towards removing H₂S from a subterranean geological formation. The present disclosure provides a method of application of ZIFs and MOFs, in general, in oilfield industries. Adding ZIF-67 NPs to WBM boosted the H₂S scavenging capacity, demonstrating the efficacy of ZIF-67 NPs in managing the risk of encountering H₂S during drilling operations. In addition to the H₂S scavenging, the inclusion of ZIF-67 into the WBM formulations also enhanced a plurality of rheological properties such as, but not limited to, plastic viscosity, yield point, and the carrying capacity of the drilling cuttings. The desirable shear-thinning behavior observed for all the ZIF-67-containing formulations further supports the favorable effect of ZIF-67 addition on the rheology of the formulated WBMs. Further, the minimal increase in the filtrate volume and the filter cake thickness at the highest ZIF-67 dosage in the WBM formulation do not compromise the beneficial effects of ZIF-67 addition. The present disclosure indicates the commercial potential of utilizing ZIF-67 to mitigate the H₂S encountered during oilfield operations and as NPs for enhancing rheological properties of drilling fluids is favorable.

Numerous modifications and variations of the present disclosure are possible in light of the above teachings. It is therefore to be understood that within the scope of the appended claims, the disclosure may be practiced otherwise than as specifically described herein.

1: A method of removing hydrogen sulfide from a subterranean geological formation, comprising:
mixing a cobalt-imidazolate ZIF-67 material with an aqueous fluid to form a drilling fluid suspension,
wherein the drilling fluid suspension has a pH of 10 or more,
wherein the cobalt-imidazolate ZIF-67 material is present in the drilling fluid suspension in an amount of 0.5 to 2.5 weight percentage (wt. %) based on the total weight of the drilling fluid suspension,
injecting the drilling fluid suspension in the subterranean geological formation,
wherein the subterranean geological formation comprises one or more hydrocarbons,
circulating the drilling fluid suspension in the subterranean geological formation and forming a water-based mud; and
scavenging hydrogen sulfide from the subterranean geological formation,
wherein the hydrogen sulfide reacts with the cobalt-imidazolate ZIF-67 material during the scavenging.

2: The method of claim 1, wherein the cobalt-imidazolate ZIF-67 material has a Brunauer-Emmett-Teller (BET) surface area of 1000 to 1300 meter squares per gram (m²/g).

3: The method of claim 1, wherein the cobalt-imidazolate ZIF-67 material has an average pore size of 1 to 3 nanometers (nm).

4: The method of claim 1, wherein the cobalt-imidazolate ZIF-67 material has a specific pore volume of 0.4 to 0.6 cubic centimeters per gram (cm³/g).

5: The method of claim 1, wherein the cobalt-imidazolate ZIF-67 material has an average particle size of 10 to 30 nm.

6: The method of claim 1, wherein the aqueous fluid comprises at least water, a bentonite, an XC-polymer, a starch, a hydroxide, and a carbonate compound.

7: The method of claim 1, wherein a breakthrough time for the hydrogen sulfide in the presence of the drilling fluid suspension is 20 to 30 times greater compared to a breakthrough time for the hydrogen sulfide in the presence of the drilling fluid suspension without the cobalt-imidazolate ZIF-67 material.

8: The method of claim 1, wherein a saturation time for the hydrogen sulfide in the presence of the drilling fluid suspension is 2 to 6 times greater compared to a saturation time for the hydrogen sulfide in the presence of the drilling fluid suspension without the cobalt-imidazolate ZIF-67 material.

9: The method of claim 1, wherein a breakthrough capacity for the hydrogen sulfide in the presence of the drilling fluid suspension is 20 to 30 times greater compared to a breakthrough capacity for the hydrogen sulfide in the presence of the drilling fluid suspension without the cobalt-imidazolate ZIF-67 material.

10: The method of claim 1, wherein a saturation capacity for the hydrogen sulfide in the presence of the drilling fluid suspension is 4 to 8 times greater compared to a saturation capacity for the hydrogen sulfide in the presence of the drilling fluid suspension without the cobalt-imidazolate ZIF-67 material.

11: The method of claim 1, wherein a plastic viscosity of the drilling fluid suspension is 1.1 to 1.5 times greater compared to a plastic viscosity of the drilling fluid suspension without the cobalt-imidazolate ZIF-67 material.

12: The method of claim 1, wherein an apparent viscosity of the drilling fluid suspension is 1.1 to 1.6 times greater compared to an apparent viscosity of the drilling fluid suspension without the cobalt-imidazolate ZIF-67 material.

13: The method of claim 1, wherein the scavenging hydrogen sulfide converts hydrogen sulfide into a hydrosulfide.

14: The method of claim 13, wherein the hydrosulfide is bound to uncoordinated open metal cobalt(II) sites and basic nitrogen sites in the cobalt-imidazolate ZIF-67 material.

15: The method of claim 1, wherein the scavenging hydrogen sulfide converts hydrogen sulfide into elemental sulfur and an insoluble sulfide.

16: The method of claim 1, wherein a gel strength of the drilling fluid suspension at a time of 10 seconds is 2 to 5 times greater compared to a gel strength of the drilling fluid suspension without the cobalt-imidazolate ZIF-67 material at a time of 10 seconds.

17: The method of claim 1, wherein a gel strength of the drilling fluid suspension at a time of 10 minutes is 1.5 to 3.5 times greater compared to a gel strength of the drilling fluid suspension without the cobalt-imidazolate ZIF-67 material at a time of 10 minutes.

18: The method of claim 1, further comprising flowing hydrogen sulfide gas into the drilling fluid suspension.

19: The method of claim 18, wherein the hydrogen sulfide gas is seeded in methane at a concentration of 100 parts per million volume (ppmv).

20: The method of claim 18, wherein the flowing of hydrogen sulfide gas is done at a rate of 50 to 150 milliliters per minute (mL/min).
